(19) United States
(12) Patent Application Publication
(10) Pub. No.: US 2009/0327078 A1
(43) Pub. Date: Dec. 31, 2009

(54) METHOD AND SYSTEM FOR DISPLAYING INFORMATION BASED ON USER ACTIONS

(75) Inventors: Chikai J. Ohazama, San Francisco, CA (US); Charles Chapin, San Jose, CA (US); Vibhor Nanavati, Sunnyvale, CA (US); Xinyu Tang, Cupertino, CA (US)

Correspondence Address: GOOGLE;Lerner, David, Littenberg, Krumholz & Mentlik, LLP, 600 South Avenue West, Westfield, NJ, 07090, US

(73) Assignee: GOOGLE INC., Mountain View, CA (US)

(21) Appl. No.: 12/489,696

(22) Filed: Jun. 23, 2009

Related U.S. Application Data
(60) Provisional application No. 61/133,089, filed on Jun. 24, 2008.

(51) Int. Cl. G06Q 30/00; G01C 21/26; G06F 3/048

(52) U.S. Cl. 705/14.54; 701/200; 705/14.49; 705/14.53; 715/769; 715/862; 715/800

(57) ABSTRACT

A system and method is provided whereby a user's interest is inferred from a user's interaction with a map. An ad is then displayed based on the inferred interest.

### CROSS-REFERENCE TO RELATED APPLICATIONS

This application claims the benefit of the filing date of U.S. Provisional Patent Application No. 61/133,089 filed Jun. 24, 2008, the disclosure of which is hereby incorporated herein by reference.

### BACKGROUND OF THE INVENTION

Systems and methods that allow users to use the Internet to search for locations on maps are well known. For example, Google Maps allows users to search for hotels in New York City, and show the locations of various hotels on a map, by simply typing the query “NYC hotels” in a textbox at maps.google.com.

It is also known to show advertisements in connection with and on maps. For example, Google's AdWords service allows a company to pick keywords that describe its Business. When users search for the keywords in connection with geographic locations or while viewing Google Maps, the company's advertisement may appear directly on and adjacent to a map that was returned in response to the search. For example, if users search in Google Maps for hotels in New York City, a number of different business ads may appear among the search results. The ads may be displayed as text and graphics adjacent to the map, and include information such as the company's business name, its URL, its address and a description of the company.

An advertisement for the company may also appear on the map itself. An icon associated with the company may denote the company's location on the map. When users click on the map marker, the map marker expands to become a window that displays more information, in addition to an image selected by the company. When the user selects the URL either adjacent or on the map, the user may be redirected to the company's website. International Publication No. WO 2007/070358, hereby incorporated by reference, discloses additional information regarding selecting and displaying advertisements in connection with maps.

### BRIEF SUMMARY OF THE INVENTION

One aspect of the invention comprises a method of providing information. The method includes: sending a map corresponding with a geographic location to a user based on a user request; receiving an action taken by the user on the map; dynamically determining a set of words based on the action; selecting information associated with the set of words; and sending the selected information to the user.

Another aspect of the invention comprises a system. The system a processor and a memory including instructions that are executable by the processor. The instructions comprise: sending a map corresponding with a geographic location to a user based on a user request; receiving an action taken by the user on the map; dynamically determining a set of words based on the action; selecting information associated with the set of words; and sending the selected information to the user.

Yet another aspect comprises of the invention relates to a method of receiving information involving providing a request provided by a user and receiving a map based on the request. Information identifying the user's movement of the map is also provided, the map being moved with the aid of a computer. The method further displays an advertisement based on the information viewable in the map and not the user's request.

A further aspect of the invention also relates to a method of receiving information. The method includes: providing a request provided by a user; receiving a map and a list of entities located on the map; providing information identifying the user's selection of an entity on the map, the selection being made with aid of a computer; and displaying an advertisement based on the user's selection of the entity, where the advertisement is not for the selected entity.

A still further aspect of the invention provides a method comprising: receiving a query from a user; providing, based on the query from the user, an image associated with a first geographic area; receiving a request from the user to change the first geographic area; providing an image associated with a second geographic area based on the user's request to change the geographic area; selecting an advertisement based on geographic features contained in the second geographic area; and providing the advertisement to the user in response to the user's request to change the geographic area.

Yet a further aspect of the invention provides a method comprising: receiving a query from a user; providing, based on the query from the user, a map and search results associated with a geographic area; selecting an advertisement based on a search result selected by the user; providing the advertisement to the user in response to the user's selection of the search result.

Another aspect provides receiving a search request from a user; transmitting a first map to the user based on the search request; receiving information indicating that the user requests to change the map; sending a second map to the user based on the indication; selecting a point of interest present in the second map but not the first map; selecting an advertisement based on the point of interest by comparing text associated with the point of interest with text associated with the map; and displaying the advertisement to the user.

Yet another aspect of the invention provides a system of providing an advertisement. The system includes a network and a user computer at one node of the network communicating with a server at another node of the network. The user computer comprising includes a user input, a processor, a display and instructions. The instructions include: providing a request from the user computer to the server; receiving a map in response to the request; providing, from the user computer to the server, an action taken by the user with the user input in connection with the map; and receiving an advertisement based on the action, the request and the map.

### BRIEF DESCRIPTION OF THE DRAWINGS

FIG. 1 is a functional diagram of a system in accordance with an aspect of the invention.

FIG. 2 is a pictorial functional diagram of a system in accordance with an aspect of the invention.

FIG. 3 is a screen shot, prior to the user action of panning, in accordance with an aspect of the invention.

FIG. 4 is a screen shot, after the user action of panning, in accordance with an aspect of the invention.

FIG. 5 is a screen shot associated with the user action of hovering in accordance with an aspect of the invention.

FIG. 6 is a screen shot associated with the user action of selecting a search result in accordance with an aspect of the invention.

FIG. 7 is a screen shot associated with the user action of selecting a photo in accordance with an aspect of the invention.

FIG. 8 is a flow chart in accordance with an aspect of the invention.

### DETAILED DESCRIPTION

In one aspect, the invention provides a system and method of displaying advertisements based on the user's actions. For example, a user may enter a text-based search for a particular geographic area, or businesses or points of interest (POI) associated with a geographic area. After a map associated with the user's requested information is displayed, advertisements may subsequently be displayed based on the user's interaction with the map, such as changing the location, viewing POI or selecting particular search results.

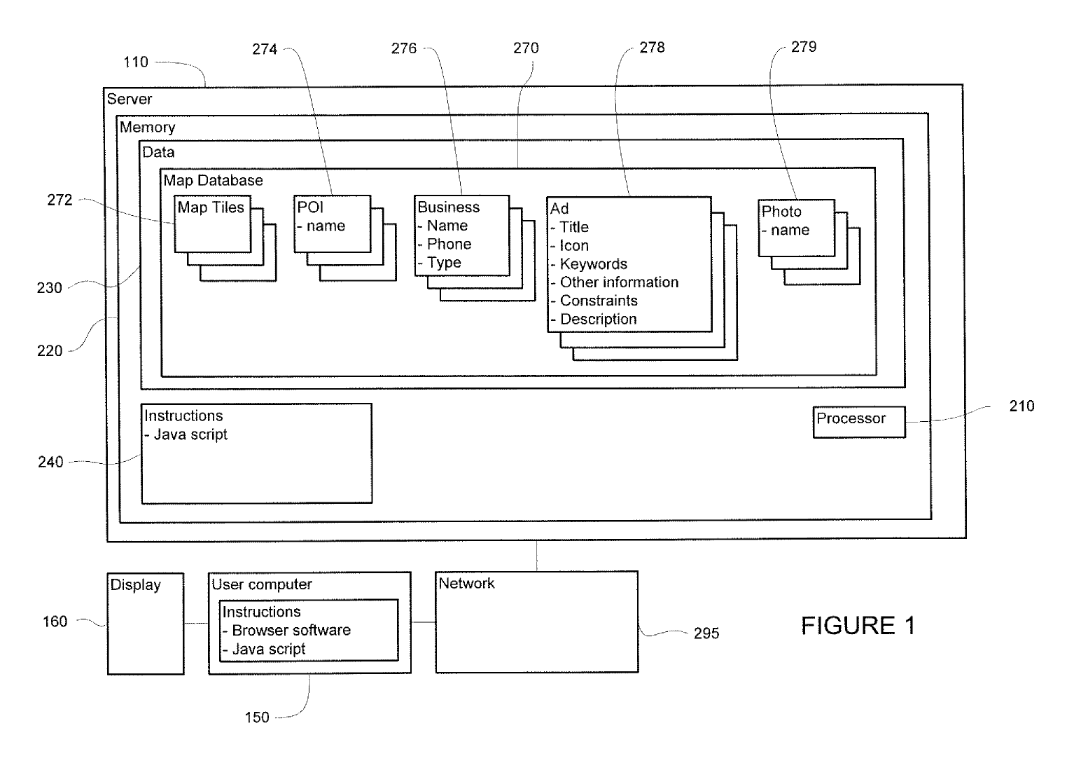

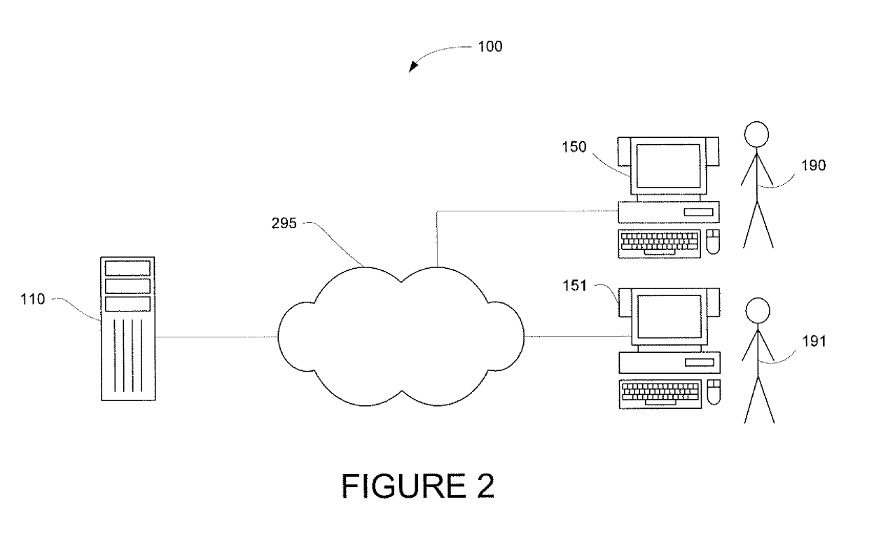

As shown in FIGS. 1-2, a system 100 in accordance with one aspect of the invention includes a computer 110 containing a processor 210, memory 220 and other components typically present in general purpose computers.

Memory 220 stores information accessible by processor 210, including instructions 240 that may be executed by the processor 210 and data 230 that may be retrieved, manipulated or stored by the processor. The memory may be of any type capable of storing information accessible by the processor, such as a hard-drive, memory card, ROM, RAM, DVD, CD-ROM, write-capable, read-only memories and other computer media.

The processor may be any number of well known processors, such as processors from Intel Corporation. Alternatively, the processor may be a dedicated controller such as an ASIC.

The instructions 240 may be any set of instructions to be executed directly (such as machine code) or indirectly (such as scripts) by the processor. In that regard, the terms “instructions,” “steps” and “programs” may be used interchangeably herein. The instructions also function as an algorithm allowing the processor to perform the purposes intended by the instructions. The instructions may be stored in object code form for direct processing by the processor, or in any other computer language including scripts or collections of independent source code modules that are interpreted on demand or compiled in advance. Functions, methods and routines of the instructions are explained in more detail below.

Data 230 may be retrieved, stored or modified by processor 210 in accordance with the instructions 240. For instance, although the invention is not limited by any particular data structure, the data may be stored in computer registers, in a relational database as a table having a plurality of different fields and records, XML documents, or flat files. The data may also be formatted in any computer readable format such as, but not limited to, binary values, ASCII or Unicode. Moreover, the data may comprise any information sufficient to identify the relevant information, such as descriptive text, proprietary codes, pointers, references to data stored in other memories (including other network locations) or information which is used by a function to calculate the relevant data.

Although the processor and memory are functionally illustrated in FIG. 1 within the same block, it will be understood by those of ordinary skill in the art that the processor and memory may actually comprise multiple processors and memories that may or may not be stored within the same physical housing. For example, some of the instructions and data may be stored on removable CD-ROM and others within a read-only computer chip. Some or all of the instructions and data may be stored in a location physically remote from, yet still accessible by, the processor. Similarly, the processor may actually comprise a collection of processors which may or may not operate in parallel.

In one aspect, computer 110 is a server communicating with one or more client computers 150-151. Each client computer may be configured similarly to the server 110, with a processor, memory and instructions. Each client computer 150-151 may be a personal computer, intended for use by a person 190-191, having all the internal components normally found in a personal computer such as a central processing unit (CPU), display 160, CD-ROM, hard-drive, user input devices (for example, a mouse, keyboard, touch-screen or microphone), speakers, modem and/or network interface device (telephone, cable or otherwise) and all of the components used for connecting these elements to one another. Moreover, computers in accordance with the systems and methods described herein may comprise any device capable of processing instructions and transmitting data to and from humans and other computers, including general purpose computers, network computers lacking local storage capability, PDA's with modems and Internet-capable wireless phones.

The server 110 and client computers 150-151 are capable of direct and indirect communication, such as over a network 295. Although only a few computers are depicted in FIGS. 1-2, it should be appreciated that a typical system can include a large number of connected computers, with each different computer being at a different node of the network 295. The network, and intervening nodes, may comprise various configurations and protocols including the Internet, intranets, virtual private networks, wide area networks, local networks, private networks using communication protocols proprietary to one or more companies, Ethernet, WiFi and HTTP. Such communication may be facilitated by any device capable of transmitting data to and from other computers, such as modems (e.g., dial-up or cable), networks and wireless interfaces. Server 110 may be a web server.

Although certain advantages are obtained when information is transmitted or received as noted above, other aspects of the invention are not limited to any particular manner of transmission of information. For example, in some aspects, the information may be sent via a medium such as a disk, tape or CD-ROM. In other aspects, the information may be transmitted in a non-electronic format and manually entered into the system. Yet further, although some functions are indicated as taking place on a server and others on a client, various aspects of the invention may be implemented by a single computer having a single processor.

The data 230 includes a map database 270. Map database 270 provides access to a variety of items based on the item's location.

Map database 270 provides maps 272 in response to requests for information associated with a geographic area. The system and method is not limited to a specific manner of expressing the location. For example, the location may be expressed in terms of street address, city name or latitude/longitude.

The system and method is not limited to a particular map type or format. The map may be returned as images, such as satellite images or street maps. The map returned by the map database 270 may be a bitmap, vector file, or other image format. In one aspect, a map to be displayed on the user computer is provided in the form of tiles, where each tile shows a portion of the map image to be displayed.

The map database may also include points of interest (POI) 274. A point of interest may be any item of interest to users that is associated with a geographical location. For example, a point of interest may be a landmark, stadium or building. A point of interest typically includes a name, such as “AT&T Park.”

Map database 270 may also be associated with businesses 276. A variety of information may be provided in connection with a business, including its name, phone number, street address and the type of business (e.g., restaurant). It will be understood that businesses 276 may include any entities having a location, including collections of businesses (such as a mall), building names as well as personal residences. It will be further understood that businesses 276 may include POI and that POI 274 may include references to businesses.

The map database is further associated with advertisements 278. Each ad may be associated with a variety of information including a title (i.e., text to be displayed when the ad is displayed), icon (e.g., a brand or other symbol to displayed), keywords (i.e., words used to retrieve the ad), constraints (i.e., conditions that need to present to display the ad or prevent the ad from being displayed) and other information. Although many of the ads may be associated with geographical areas, such as Google's Local Ads service, not all of the ads need to be associated with geographic locations. Some ads, including those used for map clips (as discussed below), may be location neutral.

It will be understood that the foregoing information described as being contained in the map database 270 is by way of example only. The database may include additional information as well, such as names of roads, lakes and directions. It will be understood that the information indicated as being stored in a single map database 270 may actually comprise a variety of different databases located in different servers in different locations.

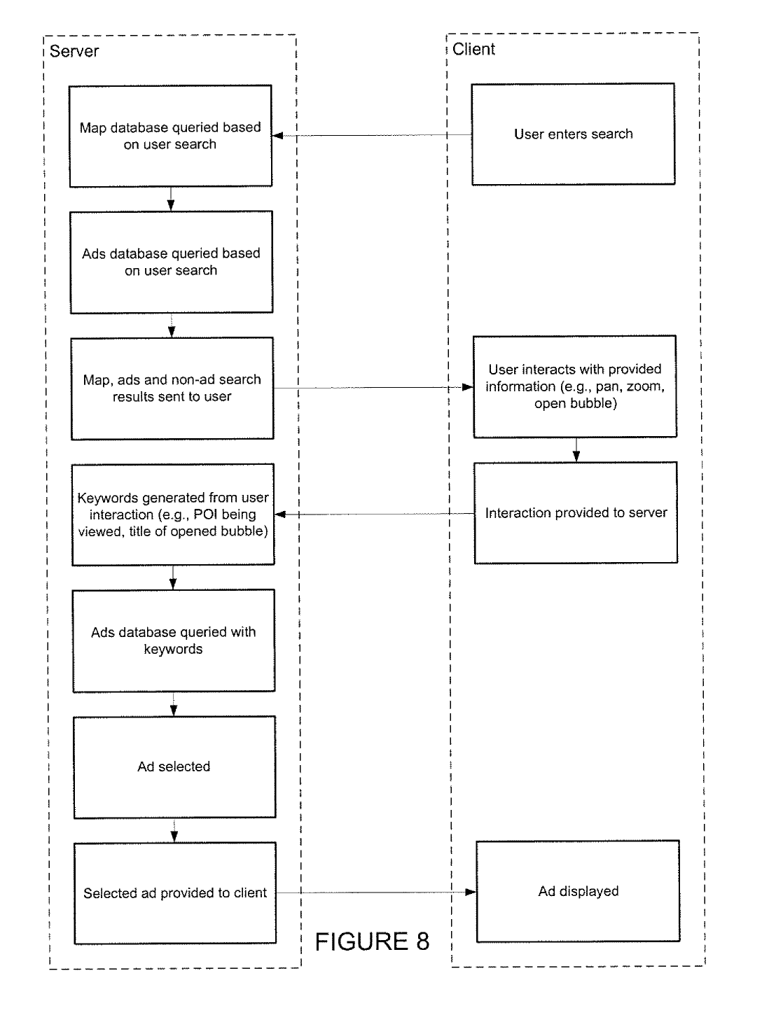

In addition to the operations illustrated in FIG. 8, various operations in accordance with a variety of aspects of the invention will now be described. It should be understood that the following operations do not have to be performed in the precise order described below. Rather, various steps can be handled in reverse order or simultaneously.

A user at computer 150 may request geographical information by connecting to server 110. For example, by logging into a website such as maps.google.com with a browser, a user may search location-specific information such as addresses, or businesses and points of interest located in particular geographical areas.

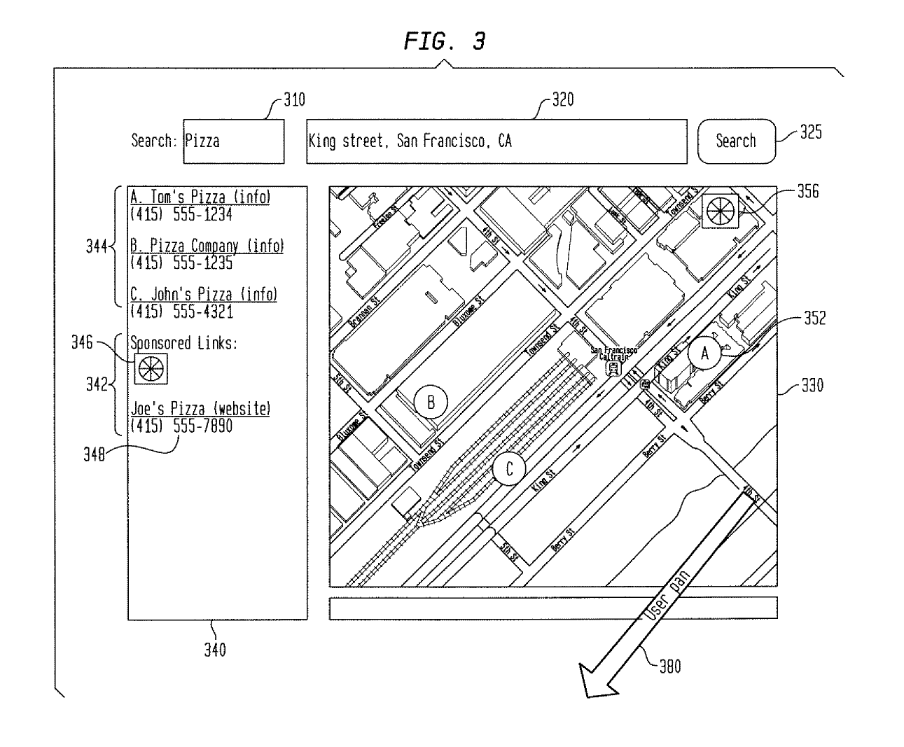

FIG. 3 illustrates how a screen in accordance with an aspect of the system and method may look when a user searches for businesses associated with a particular geographic area. Textbox 310 permits a user to enter the desired type of business and textbox 320 permits the user to enter the location to be searched. FIG. 3 illustrates the example of searching for pizza near King Street in San Francisco. When the search button 325 is selected, the search request is sent from the user's computer 150 to server 110. Accordingly, in one aspect of the invention, the user performs a first search by entering a set of words (e.g., “Phoenix”, “123 Main Street”). It will be understood that the information to be searched and the location may also be entered in the same textbox.

In response to the user's search request, server 110 queries map database 235 with the geographic area (“King Street, San Francisco”) and other information (“pizza”) associated with the request. In response, server 100 returns map tiles 272. If any businesses 276 are associated with the geographic area and other information, the businesses are returned as well. If any ads are associated with the geographic area or other information, such ads are returned as well. Ads may be selected based on their correlation to the search terms provided by the user, their association with the requested geographic area, and other information.

The information may be returned in the form of a web page for display on the user's browser. A portion 330 of the web page may thus comprise map 330. Another portion 340 may be associated with the other results of the search, such as a list 344 of the businesses that were retrieved. For example, the search for pizza may yield three pizza restaurants, all of which are listed in panel 340 devoted to search results.

Similarly, a section 342 of the search result panel 340 may display advertisements retrieved in response to the user's search request. For example, an ad entitled “Joe's Pizza” may be returned because it is associated with both the geographical area of King Street, San Francisco and the keyword “pizza.” Such ads may include both an image 346 associated with advertiser and text 348, such as a text-based hyperlink.

Information relating to the search results may also appear directly on the map 330. In that regard, an image 356 associated with the advertisers shown among the sponsored links 342 may be displayed on the map at a location designated by the advertiser. Similarly, icons associated with the other search results, such as icon 352, may be displayed on the map 330 at geographic locations associated with the search results. Both on-map icons 352 and off-map search results 344 may display unique identifiers (e.g., “A”, “B”, “C”) that are assigned after the search is performed, and allow the on-map icons to be readily associated with the search results displayed in panel 340.

As functionally shown by arrow 380 in FIG. 3, the viewable area of the map may be changed by the user such as by panning or zooming. The pan may occur as a result of the user dragging the map 330 with a mouse in the direction of arrow 380, by operating arrow keys on a keyboard, or via any other type of user input. Regardless of the type of user action, the user's action (either the action itself such as “mouse drag 50 pixels to the left” or the request “move map two tiles”) may be provided by the user computer 150 to the server 110.

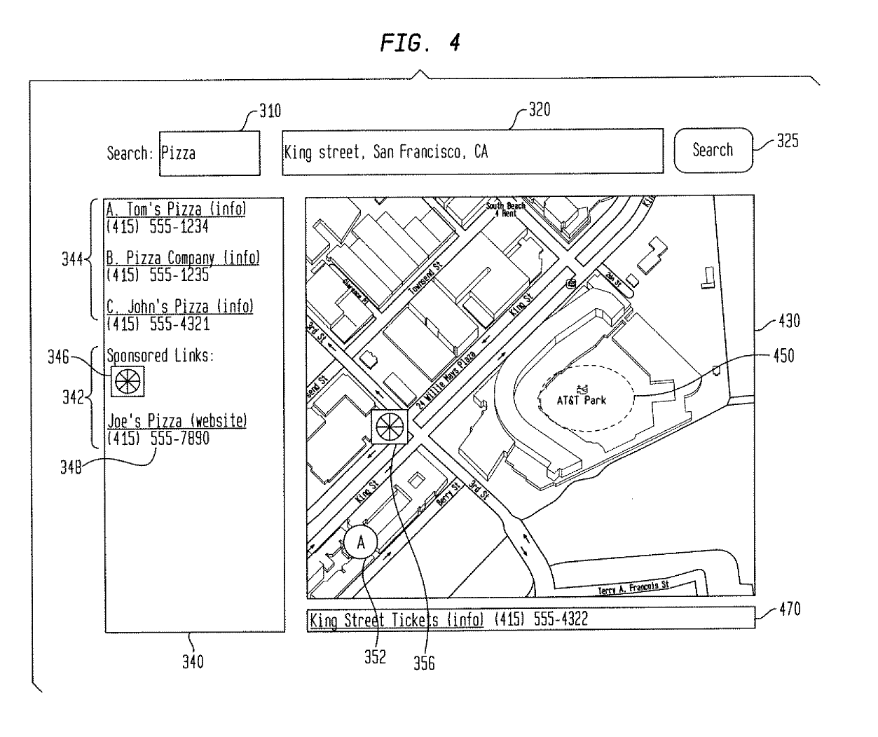

FIG. 4 illustrates a screen that may be displayed as a result of the user's action of panning map 330 shown in FIG. 3. Depending on the direction and magnitude of the pan, portions of the prior viewable areas of the map may remain viewable—along with the new portions of the map—after the map is dragged. For instance, icons 352 and 356 (which were returned and displayed in response to the search request entered by the user) remain visible.

As a result of the user moving the viewable area of the map, the system and method attempts to determine what the user may be interested in and display information, such as an ad, based on the inferred interest.

In one aspect of the system and method, the user's interest is inferred by analyzing the information being displayed to the user, with or without regard to the user's original search.

One manner in which the user's interest may be inferred is by determining whether the viewable area of the map is showing any points of interest. For example, the only point of interest shown on map 430 is AT&T Park 450.

If the user moved the map until a particular point of interest was displayed, it is possible that the user is interested in that particular point of interest even though the user's original search query was not directed towards the point of interest. Using the example values shown in FIGS. 3 and 4, the user searched for pizza on King Street in San Francisco. The user then moved the map until it was showing AT&T Park. Therefore, the user may have always been interested in AT&T Park or gained an interest in AT&T Park.

In accordance with one aspect of the invention, the point of interest being displayed as a result of user action may thus be used to perform an additional search for additional information to be displayed to the user. For instance, the name of the point of interest may be used as a keyword to select advertisements. By way of example, ads 278 (FIG. 1) may be searched for entities using the search term “AT&T Park.” In response, an ad for “King Street Tickets” may be found if the “King Street Tickets” ad's keywords included the term “AT&T Park.”

The ad or ads selected as a result of inferring the user's interest from a user's interaction with a map (hereafter, a “map clip”) is then displayed to the user. For example, the map clip 470 may be displayed directly below the map 430.

One aspect of the invention comprises selecting only a single ad as the map clip. Preference may be given to ads associated with the particular geographical area being currently being displayed in the map. In another aspect, the title of the ad and other information associated with the ad are displayed on a single line. If the map clip is associated with a particular location that is currently viewable on map 430, an icon associated with the selected ad may be shown both below the map (in area 470) and in the appropriate spot on map 430.

As shown in FIG. 4, the system and method may continue to display the results based on the user's initial search at the same time it displays the results based on the user's actions. In another aspect, the prior search results may be replaced with the ads selected based on the user's actions. In yet another aspect, the search results may be refreshed.

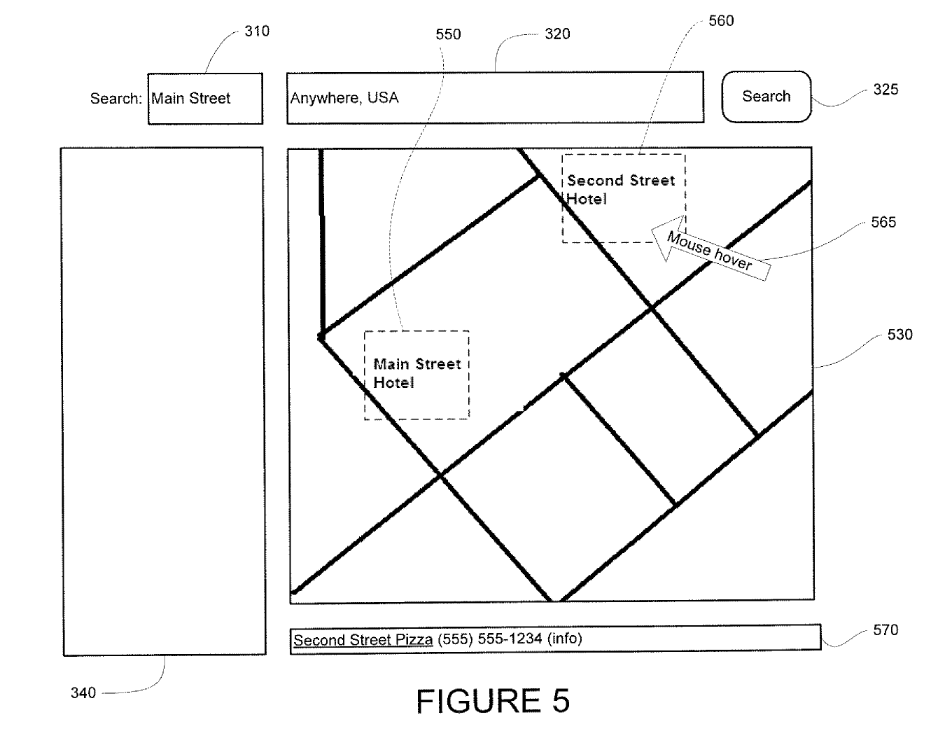

Other types of user actions may also be used to infer the user's interest, such as determining whether the mouse cursor is hovering over a particular POI as shown in FIG. 5. Map 530 illustrates a map that was returned in response to the user searching for “Main Street” in the town of “Anywhere, USA.” The map also displays two POI, namely the “Main Street Hotel” POI 550 and “Second Street Hotel” POI 560.

If the user hovers the mouse over the location of a POI, the characteristics of the POI may be used to select an advertisement. For example, as shown by arrow 565, the user may hover the mouse cursor over the “Second Street Hotel” POI 560 for more than 2 seconds. If so, the system may use the name of POI 560, namely the term “Second Street Hotel,” as well as the location being displayed in map 530 to query ads 278. The ad returned as a result of such a query, such as “Second Street Pizza” (which may be associated with the keyword “Second Street”) may then be shown as map clip 570 below the map 530.

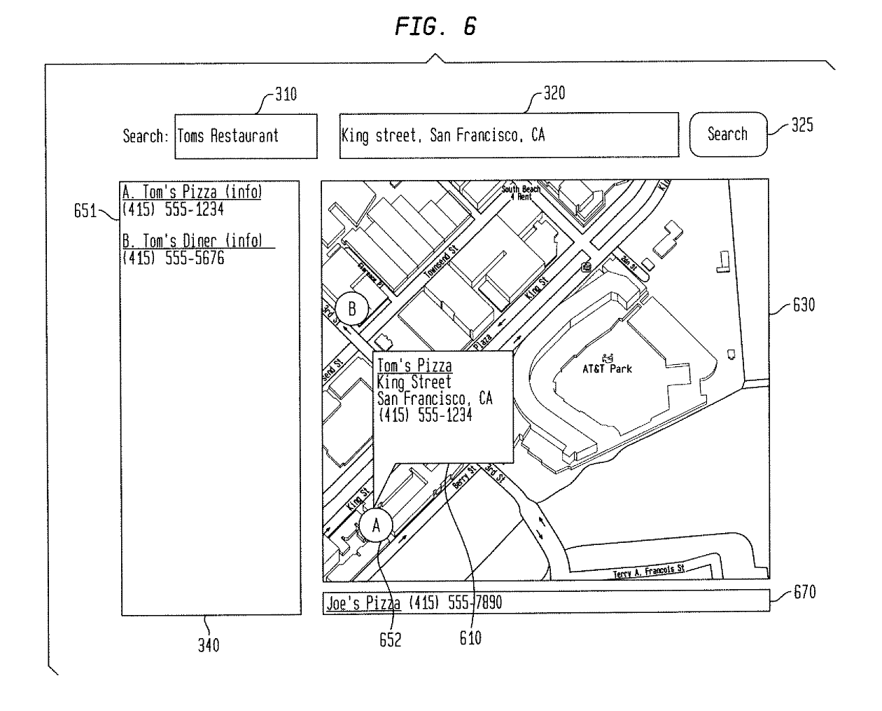

The system and method may also use other actions to select to select an advertisement, such as the user's selection of a particular search result. As shown in FIG. 6, the system and method may provide for the display of additional information (such as bubble 610) upon the selection of the text 651 associated with a search result (including advertisements such as sponsored links) or the icon 652 associated with the search result. In the case of a business, the additional information may include the address of the business. In the case of an ad, the additional information may also include a photograph and description provided by the advertiser. The search result may be selected by clicking, hovering the cursor over the text 651 or icon 652, or any other user input.

The information associated with the selected search result or displayed in the bubble may be used to select the map clip. For example, if the user searched for “Toms Restaurant” and clicked the icon for “Tom's Pizza,” it may be inferred from the user's selection of the search result that the user is interested in pizzerias in spite of the fact that the user's original search made no mention of pizzerias. Accordingly, the name of the search result selected by the user (e.g., “Tom's Pizza”) may be used as a keyword to search for advertisements. A resulting ad (e.g., an ad entitled “Joe's Pizza” that is associated with the keyword “pizza”) may then be selected and displayed as map clip 670. In this aspect of the invention in particular, it will be noted that the user may be presented with an ad that is targeted to his or her interest—as determined by the user's actions—even though the user's text-based search did not reveal such an interest. Furthermore, the resulting ad could be for the same business as the one selected by the user.

Other information selected by the user may also be used to determine the user's interest. As shown in FIG. 1, some aspects of the system and method allow users to upload photos 279 and associate them with particular points on a map, such as Google's Panoramio and Google Maps services. The photos may further be associated with names and descriptions, which are typically provided by the users that uploaded the photos.

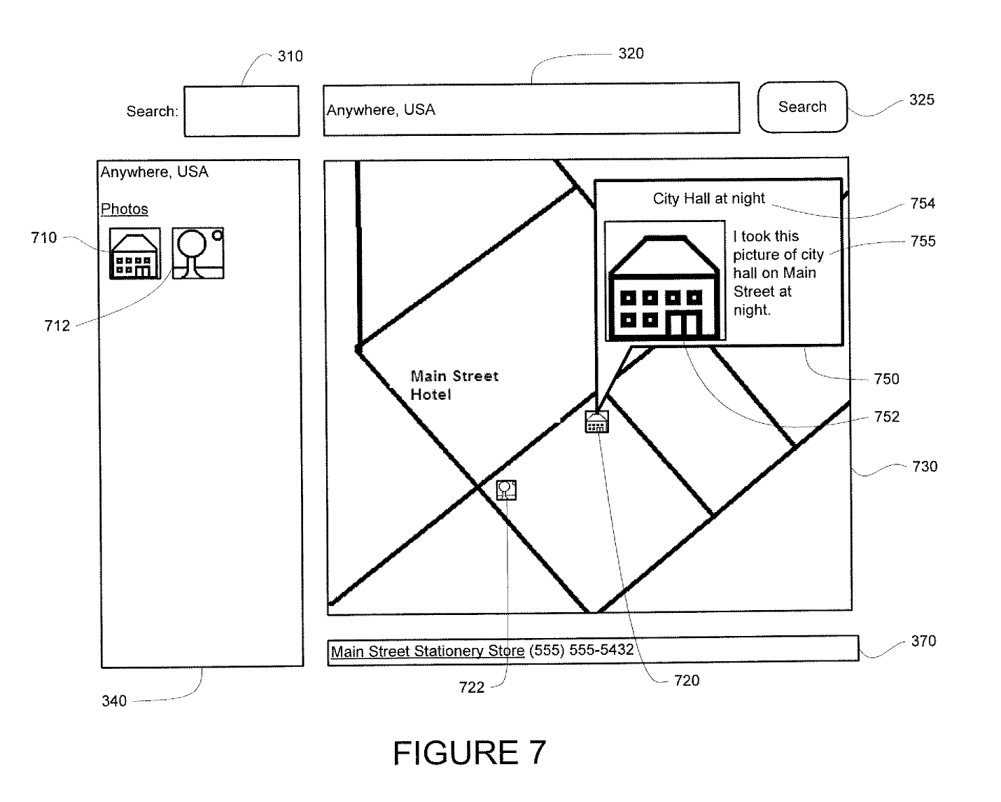

If the photo is associated with a particular point on a map, it may be shown in various places and resolutions on the user's screen. For example, as illustrated in FIG. 7, a photo may be shown off of the map (photos 710, 712) and as icons on the map at the locations associated with the photos (photos 720, 722).

Similar to the bubbles described above, the photos may also be shown in pop-up windows that appear when a photo is selected by the user, such as by selecting a photo 710 from the results pane or icon 720 from the map 730. The bubble 750 may include a higher resolution view of the photo 752, the photo's title 754 and a description 755 of the photo.

When the photo is selected, the title or other information associated with the photo may be used as keywords for the selection and display of a map clip. Using the foregoing example, querying the ads 278 with the search term “City Hall at night” (based on the title of the photo) and the geographic location currently being viewed may return an ad for “Main Street Stationary Store” if the ad was associated with the keywords “city hall” and the location shown in map 730.

Other user interests may also be inferred. For example, if the map displays a button to display the amount of traffic on a road, the current name of the city and the word “traffic” may be used, together, to query and select a map clip from the ad database when the button is selected. In another case, the application may find the nearest city for a given view port and use the first popular search term that has ads, i.e. “fisherman's wharf”. For instance, the user may initially search in a first city (e.g., Los Angeles) and then pan/zoom to a second city (e.g., San Francisco). However, if the map view covers the entire city and the user has not zoomed in close enough to a specific point of interest, the application may show ads based on what the top search items are in the second city (e.g., fisherman's wharf).

More generally, if a user turns on a layer, the application may request ads relative to the layer that was turned on. Other layers besides traffic could include weather (e.g., find ads about storms/weather/etc. in a city such as San Francisco), terrain (e.g., find ads about hiking/biking in San Francisco), or a YouTube layer (e.g., find videos of San Francisco). Thus, the user may select some kind of data to be displayed in the map, which could be expressed as enabling the user to select a data set (e.g., a layer or overlay) to be displayed in the map display, such as by selecting a “Traffic” (or other) button or other type of actuator, or by selecting a checkbox or other actuator associated with a “Terrain” entry (or other entry) in a list of available layers/overlays.

As indicated above, various aspects of the invention relate to dynamically determining keywords or other search criteria by generating them after, and based in whole or in part on, the actions of the user in connection with a map. These keywords or criteria may then be used to select an advertisement which is intended to reflect the interests of the user. The advertisement may be selected based on the action alone (e.g., panning to a POI) or in combination with the original search, the general geographic area covered by the map, or both.

One of the advantages of the present invention is its ability to accommodate a wide variety of alternatives to the example structural elements and operations discussed above.

The user's actions and the search results may be transmitted and rendered in any number of ways. For example, the server 100 may transmit a static web page containing all of the requested information. Similarly, the user's request for new information may be determined by the selection of a hyperlink (such as a hyperlink to pan the map) and transmitted as a request for a new web page. Alternatively, the server 100 may transmit a web page containing Java Script which allows individual portions of the page (such as the search results or map) to be updated without updating the other portions of the page. Similarly, Java Script may permit individual user actions (such as request to the move the map) to be transmitted directly to the server without sending an entirely new web page. In this regard, the invention is particularly advantageous when inferring interest from mouse-based actions such as dragging.

It will be understood that when map clips are selected, the ads may be selected based on more criteria than simply keywords and geographic location. For example, the popularity of the ad, the amount charged for the ad and many other factors may be used.

Moreover, the search query used to select the map clip need not be text based. For example, if the user views a photo on a map and a number of ads are associated with different photos, an ad may be selected based on the visual similarity of the ad's photo to the photo selected by the user.

Most of the foregoing alternative embodiments are not mutually exclusive, but may be implemented in various combinations to achieve unique advantages. As these and other variations and combinations of the features discussed above can be utilized without departing from the invention as defined by the claims, the foregoing description of the embodiments should be taken by way of illustration rather than by way of limitation of the invention as defined by the claims. It will further be understood that many of the foregoing references to businesses and locations are fictional and for illustration purposes only.

1. A method of providing information comprising:
sending a map corresponding with a geographic location to a user based on a user request;
receiving an action taken by the user on the map;
determining, with a processor, a set of words based on the action;
selecting information associated with the set of words; and
displaying the selected information to the user on a display.

2. The method of claim 1 wherein the request comprises a geographic location.

3. The method of claim 2 wherein the geographic location is a street address.

4. The method of claim 2 wherein the geographic location is a city name.

5. The method of claim 1 wherein the action comprises changing the geographic location to a second geographic location, and further comprising sending a map of the second geographic location to the user.

6. The method of claim 5 wherein the set of words is determined based on a feature displayed in the map of the second geographic location.

7. The method of claim 6 wherein the feature is a point of interest.

8. The method of claim 5 wherein the action comprises dragging the map to the second geographic location.

9. The method of claim 5 wherein determining the set of words based on the action includes determining a set of search terms associated with the second geographic location.

10. The method of claim 1 wherein the action comprises changing the zoom level of the map.

11. The method of claim 1 wherein the selected information comprises an advertisement associated with keywords, and wherein the advertisement is selected based on the correspondence between the keywords and the determined set of words.

12. The method of claim 1 wherein the set of words comprises a single word.

13. The method of claim 12 wherein the set of words comprises a plurality of words.

14. The method of claim 1 wherein:
receiving the action taken by the user on the map includes receiving a selection by the user of a data set to be displayed on the map; and
determining the set of words based on the action includes determining the set of words based on the selected data set.

15. The method of claim 1 wherein displaying the selected information to the user comprises sending the selected information over a network for display on a display associated a computer associated with the user.

16. A method of providing information comprising:
sending a map corresponding with a geographic location to a user based on a user request;
sending a plurality of search results to the user based on the user request, the search results being associated with locations on the map;
receiving an identification of a search result selected by the user;
determining, with a processor, a set of words based on the selected search result;
selecting information associated with the set of words; and
displaying the selected information to the user on a display.

17. The method of claim 16 wherein the search results comprise businesses associated with locations within the map.

18. The method of claim 17 wherein the set of words is determined based on the name of the business.

19. A method of providing information comprising:
sending a map corresponding with a geographic location to a user based on a user request;
receiving data identifying the movement of a mouse by the user to a location on the map;
determining, with a processor, a set of words based on the mouse movement;
selecting information associated with the set of words; and
displaying the selected information to the user on a display.

20. The method of claim 19, further comprising the user hovering the mouse cursor over the location.

21. The method of claim 20, wherein the location of the mouse cursor is associated with a point of interest, and the point of interest is used to determine the set of words.

22. The method of claim 21 wherein the set of words is determined based on the name of the point of interest.

23. A method of providing information comprising:
sending a map corresponding with a geographic location to a user based on a user request;
sending a photo associated with the map to the user;
receiving data identifying the user's selection of the photo;
determining, with a processor, a set of words based on text associated with the photo;
selecting information associated with the set of words; and
displaying the selected information to the user on a display.

24. The method of claim 22 wherein the photo is associated with text, and the second set of words is based on the.

25. A system of providing information comprising:
a processor;
a memory comprising instructions executable by the processor;
the instructions comprising:
sending a map corresponding with a geographic location to a user based on a user request;
receiving an action taken by the user on the map;
dynamically determining a set of words based on the action;
selecting information associated with the set of words; and
sending the selected information to the user.

26. The system of claim 25 wherein the processor is located at one node of a network and the user request is provided from a computer at another node of the network.

27. The system of claim 26 wherein the network is the Internet.

28. The system of claim 25 wherein the action is taken by the user with a mouse.

29. The system of claim 25 wherein the action is taken by the user with a keyboard.

30. The system of claim 25 wherein the system is a web server.

31. The system of claim 25 wherein dynamically determining the set of words based on the action includes dynamically determining a set of search terms associated with the second geographic location.

32. The system of claim 25 wherein the system is a web server.

33. A method of receiving information comprising:
providing a request provided by a user;
receiving a map based on the request;
providing information identifying the user's movement of the map, the map being moved with the aid of a computer; and
displaying an advertisement based on the information viewable in the map and not the user's request.

34. The method of claim 32 wherein the request is provided over a network to a server.

35. The method of claim 32, wherein the map is moved by the user with a mouse.

36. A method of receiving information comprising:
receiving a request provided by a user via an electronic user input device;
receiving a map and a list of entities located on the map over a network;
providing information identifying the user's selection of an entity on the map, the selection being made with the aid of a computer; and
displaying an advertisement based on the user's selection of the entity, where the advertisement is not for the selected entity.

37. The method of claim 36 wherein the request is provided over a network to a server.

38. The method of claim 37, wherein the map is moved by the user with a mouse.

39. A method of providing information comprising:
receiving a query from a user;
providing, based on the query from the user, an image associated with a first geographic area;
receiving a request from the user to change the first geographic area;
providing an image associated with a second geographic area based on the user's request to change the geographic area;
selecting an advertisement based on geographic features contained in the second geographic area;
providing the advertisement to the user in response to the user's request to change the geographic area.

40. A method of providing information comprising:
receiving a query from a user;
providing, based on the query from the user, a map and search results associated with a geographic area;
selecting an advertisement based on a search result selected by the user;
providing the advertisement to the user in response to the user's selection of the search result.

41. A method of providing an advertisement to a user comprising:
receiving a search request from a user;
transmitting a first map to the user based on the search request;
receiving information indicating that the user requests to change the map;
sending a second map to the user based on the indication;
selecting a point of interest present in the second map but not the first map;
selecting an advertisement based on the point of interest by comparing text associated with the point of interest with text associated with the map; and
displaying the advertisement to the user.

42. A system of providing an advertisement comprising:
a network; and
a user computer at one node of the network communicating with a server at another node of the network; and
the user computer comprising a user input, a processor, a display and instructions;
the instructions comprising: providing a request from the user computer to the server; receiving a map in response to the request; providing, from the user computer to the server, an action taken by the user with the user input in connection with the map, and; receiving an advertisement based on the action, the request and the map.

43. The system of claim 42 wherein the user input is a mouse.

44. The system of claim 42, wherein the action comprises moving the map.

45. The system of claim 42, wherein the advertisement is based on the action, words contained in the request and geographic location covered by the map.
